(19) United States
(12) Patent Application Publication
(10) Pub. No.: US 2026/0010137 A1
(43) Pub. Date: Jan. 8, 2026

(54) CONTROL DEVICE, INDUSTRIAL MACHINE SYSTEM, EXECUTION-HISTORY DATA DISPLAY METHOD, AND PROGRAM

(71) Applicant: FANUC CORPORATION, Yamanashi (JP)

(72) Inventor: Yuta Namiki, Yamanashi (JP)

(21) Appl. No.: 18/992,725

(22) PCT Filed: Oct. 5, 2022
(86) PCT No.: PCT/JP2022/037313

§ 371 Date: Jan. 9, 2025

(51) Int. Cl. G05B 19/4063

(52) U.S. Cl. CPC G05B 19/4063; G05B 2219/35291

(57) ABSTRACT

Provided is a control device for controlling an industrial machine, wherein the control device comprises: a storage unit that stores execution-history data from when a program is executed, the program causing the industrial machine to perform prescribed work; and a history display unit that displays, on a display screen and as a table, execution-history data, such display being performed on the basis of the hierarchical structure of the execution-history data.

### CROSS-REFERENCE TO RELATED APPLICATIONS

This application is a National Stage application of International Application No. PCT/JP2022/037313 filed Oct. 5, 2022.

### BACKGROUND

### Field

The present disclosure relates to a control device, a system of an industrial machine, an execution history data display method, and a program.

### Discussion of the Related Art

A robot system for detecting a workpiece by a visual sensor mounted on a robot and performing work such as picking-up of a workpiece has been known. In such a robot system, execution history data are output by execution of a robot program and are used for investigating a cause when an error occurs in a motion of a robot due to non-detection, false detection, and the like of a workpiece.

In relation to this, Japanese Unexamined Patent Publication (Kokai) No. H07-129220A describes a robot control device having functions of storing a program execution history during reproduction operation of a robot motion program, and displaying the program execution history on a display when necessary. Regarding the program execution history, Japanese Unexamined Patent Publication (Kokai) No. H07-129220A describes as follows: “for statements for maximum N rows, a program name, a row number, information indicating distinction between progress execution and regression execution, and information indicating distinction among an unexecuted state, a pause state, and an executed state relating to an execution state are stored” (paragraph 0018).

Japanese Patent No. 7104264B describes a history management device included in a robot system including a robot on which a visual sensor is mounted. Japanese Patent No. 7104264B describes that execution history information is arranged in order of time and is displayed (paragraph 0041).

### SUMMARY

Depending on the type of a sensor mounted on a robot or a task, various types of data may be included in an execution history. Further, the structure of execution history data may change depending on the difference in the configuration of a robot program or an execution command to be used. Therefore, it is difficult for a general user to process and display, on a device, such execution history data in such a way that the execution history data can be effectively used. A technique for enabling a user to display, on a device, the execution history data in such a way that a user can effectively use the execution history data is desired.

One aspect of the present disclosure is a controller for controlling an industrial machine, and the controller includes: a storage unit configured to store execution history data when a program for causing the industrial machine to perform predetermined work is executed; and a history display unit configured to display, on a display screen, the execution history data in tabular format, based on a hierarchical structure of the execution history data. Another aspect of the present disclosure is a controller for controlling an industrial machine, and the controller includes: a storage unit configured to store execution history data when a program for causing the industrial machine to perform predetermined work is executed; a history display unit configured to display, on a display screen, the execution history data in tabular format; a selection unit configured to select, from the execution history data, data to be displayed in the tabular format on the display screen by the history display unit; and an output unit configured to output, as a data file in tabular format, the execution history data displayed in the tabular format on the display screen.

The objects, the features, and the advantages, and other objects, features, and advantages will become more apparent from the detailed description of typical embodiments of the present invention illustrated in accompanying drawings.

### BRIEF DESCRIPTION OF DRAWINGS

FIG. 1 is a diagram illustrating a configuration of a robot system including a robot controller according to a first embodiment.

FIG. 2 is a diagram illustrating a hardware configuration example of the robot controller and a teach pendant.

FIG. 3 is a functional block diagram of the robot controller and a visual sensor control device.

FIG. 4 is an example of an execution history list screen when a list of execution history files is displayed.

FIG. 5 is a flowchart illustrating a first example of history data display processing.

FIG. 6 is a diagram illustrating an example of execution history data acquired by executing a vision program.

FIG. 7 is a diagram illustrating an example of data in tabular format being acquired by converting the execution history data.

FIG. 8 is a diagram illustrating a state where the tabular data are output as a table data file.

FIG. 9 is a diagram illustrating an example of a setting screen for narrowing criteria setting.

FIG. 10 is a flowchart illustrating a second example of the history data display processing.

FIG. 11 is a diagram illustrating a configuration of a robot system according to a second embodiment, and also illustrating functional blocks of a robot controller.

FIG. 12 is a diagram illustrating an example of execution history data generated by executing a force control program.

FIG. 13 is a diagram illustrating a display example when the execution history data in FIG. 12 are illustrated in tabular format.

### DESCRIPTION OF EMBODIMENTS

Next, embodiments of the present disclosure will be described with reference to drawings. A similar configuration portion or a similar functional portion is denoted by the same reference sign in the referred drawings. A scale is appropriately changed in the drawings in order to facilitate understanding. An aspect illustrated in the drawing is one example for implementing the present invention, and the present invention is not limited to the illustrated aspect.

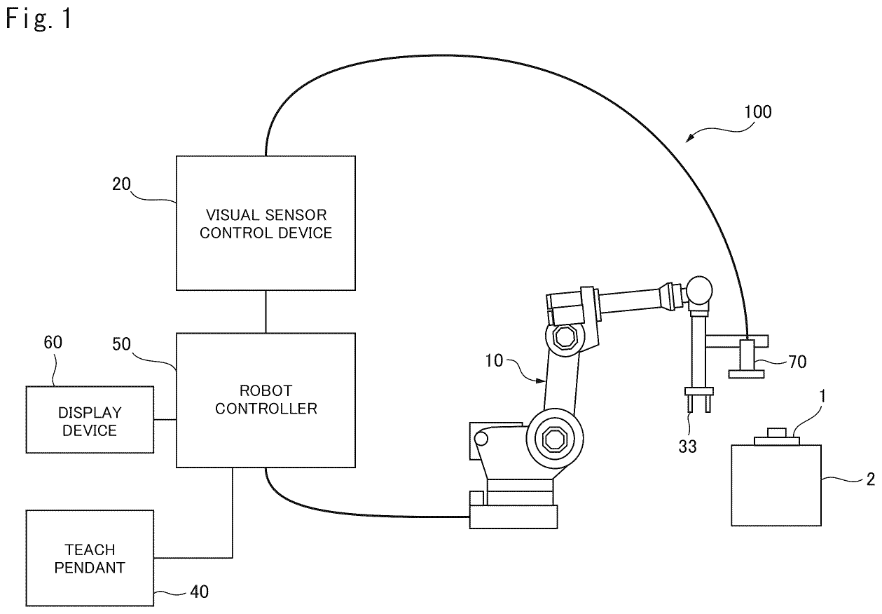

FIG. 1 is a diagram illustrating a configuration of robot system 100 including robot controller 50 according to a first embodiment. Robot system 100 is an exemplification of a robot system including a robot on which a sensor is mounted. Robot system 100 is configured as a system capable of recording and displaying execution history data when Robot 10 is controlled to perform predetermined work.

As illustrated in FIG. 1, robot system 100 includes robot 10 including hand 33 mounted on an arm tip portion, robot controller 50 that controls robot 10, a teach pendant 40 connected to robot controller 50, visual sensor 70 attached to the arm tip portion of robot 10, and visual sensor control device 20 that controls visual sensor 70. Robot system 100 can detect target object 1 on worktable 2 by visual sensor 70, and perform handling of target object 1 with hand 33 mounted on robot 10. Robot system 100 may further include display device 60 for displaying the execution history data. Display device 60 is connected to robot controller 50 via, for example, a network. It should be noted that FIG. 1 illustrates the configuration example when display device 60 and teach pendant 40 are provided as separate devices in the robot system 100, but the function as display device 60 may be integrally incorporated into the teach pendant 40.

Robot 10 is a vertical articulated robot in the present embodiment, but a robot of other types such as a parallel link robot and a dual arm robot may be used according to the purpose of work. Robot 10 can perform desired work by an end effector attached to a wrist portion. The end effector is an external device which is exchangeable according to use, and is, for example, a hand, a welding gun, a tool, and the like. FIG. 1 illustrates an example in which hand 33 as the end effector is used.

Visual sensor control device 20 has a function of controlling visual sensor 70 and a function of executing image processing on an image captured by visual sensor 70. Visual sensor control device 20 detects a position of target object 1 from the image captured by visual sensor 70, and provides the detected position of target object 1 to robot controller 50. In this way, robot controller 50 can correct a teaching position, and perform picking-up and the like of the target object 1.

Visual sensor 70 may be a camera that captures a gray-scale image or a color image or may be a stereo camera or a three-dimensional sensor that can acquire a distance image and a three-dimensional point group. In robot system 100, a plurality of visual sensors may be arranged. Visual sensor control device 20 holds a model pattern of a target object, and can execute image processing of detecting a target object by pattern matching between an image of the target object in a captured image and the model pattern. It should be noted that, in FIG. 1, visual sensor control device 20 is formed as a device separately provided from robot controller 50, but a function as visual sensor control device 20 may be embedded in robot controller 50.

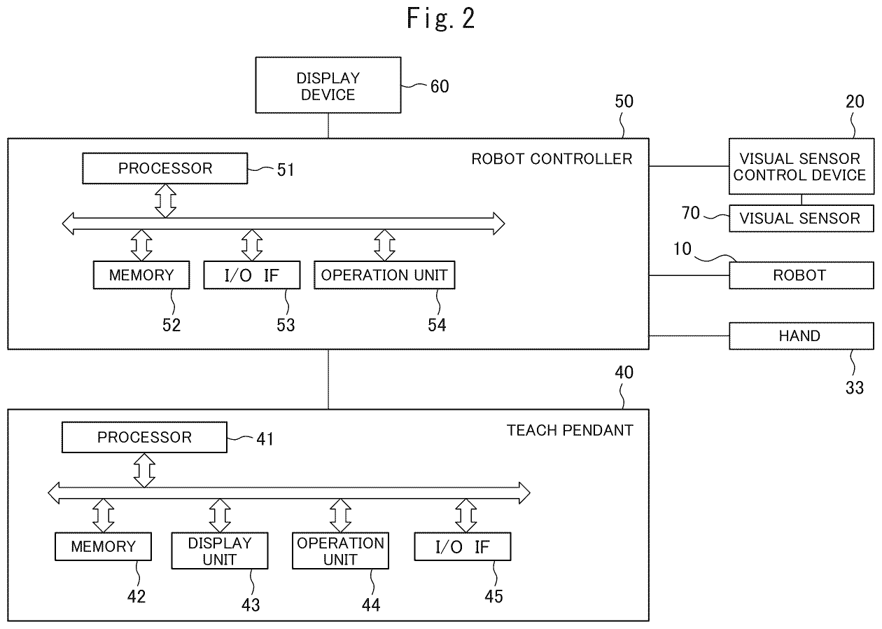

FIG. 2 is a diagram illustrating a hardware configuration example of robot controller 50 and teach pendant 40. Robot controller 50 may have a configuration as a general computer in which memory 52 (such as a ROM, a RAM, and a non-volatile memory), input/output interface 53, operation unit 54 including various operation switches, and the like are connected to processor 51 via a bus. Teach pendant 40 is used as a device for performing data input and displaying information for teaching of robot 10 (i.e., creating a control program). Teach pendant 40 may have a configuration as a general computer in which memory 42 (such as a ROM, a RAM, and a non-volatile memory), display unit 43, operation unit 44 formed of an input device such as a keyboard (or a software key), input/output interface 45, and the like are connected to processor 41 via a bus. It should be noted that a teaching device formed of an information processing device such as a tablet computer and a smartphone may be used as teach pendant 40.

Display device 60 may also have a configuration as a general computer in which memory (such as a ROM, a RAM, and a non-volatile memory), an input/output interface, a display unit, an operation unit, and the like are connected to a processor via a bus. Further, visual sensor control device 20 may have a configuration as a general computer in which a memory (such as a ROM, a RAM, and a non-volatile memory), an input/output interface, a display unit, an operation unit, and the like are connected to a processor via a bus.

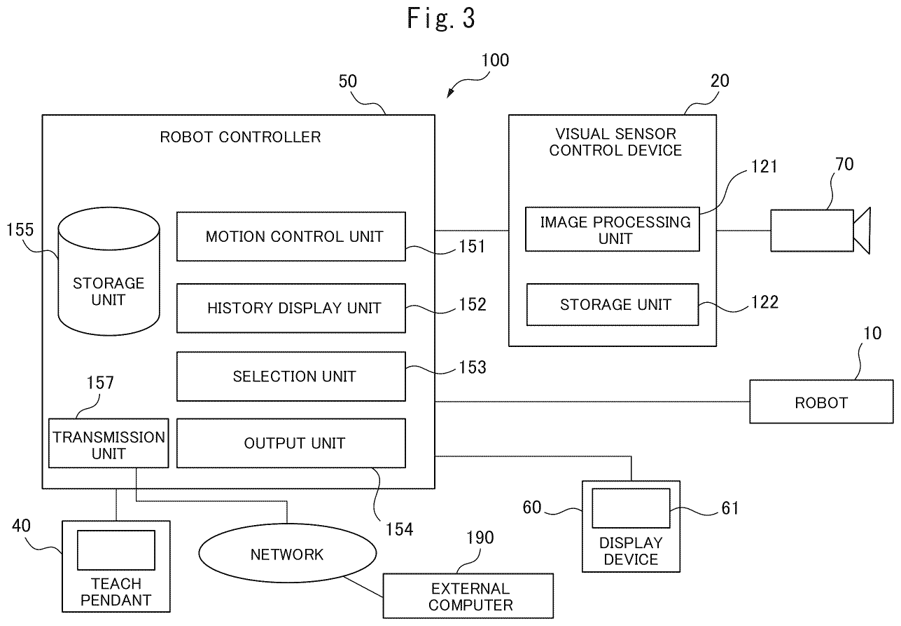

FIG. 3 illustrates a functional block diagram of robot controller 50 and visual sensor control device 20. As illustrated in FIG. 3, robot controller 50 includes motion control unit 151, history display unit 152, selection unit 153, output unit 154, and storage unit 155. Robot controller 50 may further include transmission unit 157. The functional blocks of motion control unit 151, history display unit 152, selection unit 153, output unit 154, and transmission unit 157 may be achieved by processor 51 of robot controller 50 executing software.

Storage unit 155 is a storage device formed of a non-volatile memory, a volatile memory, or the like. A robot program for controlling robot 10, a program (hereinafter also described as a vision program) for executing image processing such as detection of a workpiece, based on an image captured by the visual sensor 70, and the like are stored in storage unit 155. Execution history data as a result of executing a program such as the vision program may be recorded in storage unit 155.

Motion control unit 151 controls the motion of a robot according to a control program. Robot controller 50 includes a servo control unit (not illustrated) that performs servo control on a servo motor of each axis according to a command for each axis generated by motion control unit 151.

History display unit 152 provides functions of reading the execution history data recorded in storage unit 155, and displaying the execution history data in tabular format. History display unit 152 may operate to display the execution history data on, for example, display screen 61 of display device 60.

Selection unit 153 provides a function for selecting, from the execution history data, data to be displayed in tabular format by history display unit 152. In other words, selection unit 153 provides a function of narrowing down data to be displayed as the execution history data.

Output unit 154 provides a function of outputting, as a data file in tabular format, the execution history data displayed in tabular format.

Transmission unit 157 provides a function of transmitting the execution history data in tabular format to external computer 190 via a network. In this way, the execution history data in tabular format can be displayed and analyzed on the external computer 190. Transmission unit 157 may transmit the data file in tabular format provided by output unit 154 to external computer 190. It should be noted that external computer 190 may include an external computer connected via various networks, an apparatus that provides a service by cloud computing, and the like.

Visual sensor control device 20 includes image processing unit 121 and storage unit 122. Storage unit 122 stores various types of data needed for image processing, such as calibration data and model data about a workpiece. Image processing unit 121 executes various types of image processing such as detection processing of a workpiece.

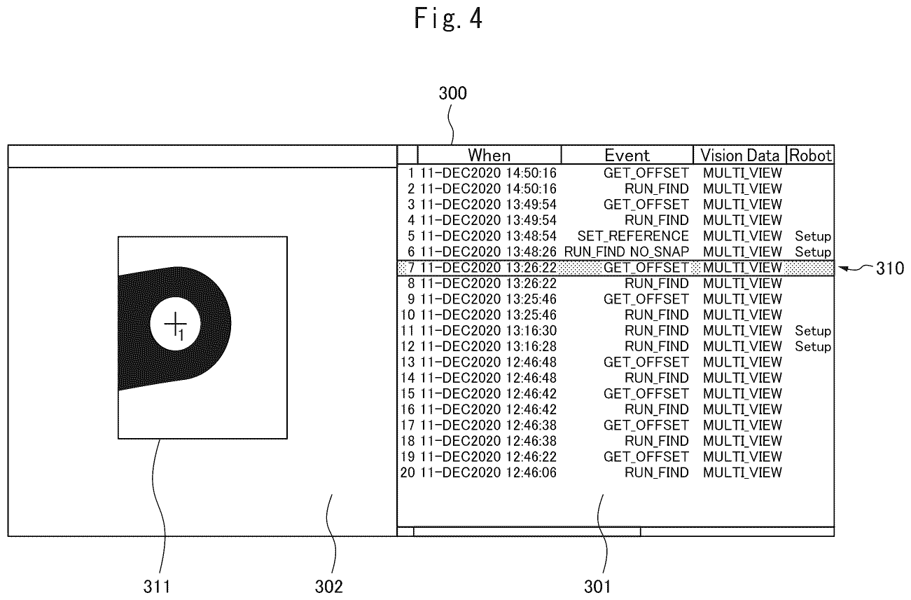

FIG. 4 is an example of execution history list screen 300 when a list of execution history files stored in storage unit 155 is displayed. Such a display of the list screen of the execution history files may be provided as one of the functions of history display unit 152. Execution history list screen 300 includes list display region 301 for displaying a list of execution histories, and detection result display region 302. 20 execution history files are displayed in list display region 301. When an operator selects one of the execution history files, an image of a detection result included in the execution history file may be displayed in detection result display region 302. In the screen example in FIG. 4, seventh execution history file 310 (event name “GET_OFFSET”) is selected, and image 311 of a detection result is displayed in detection result display region 302.

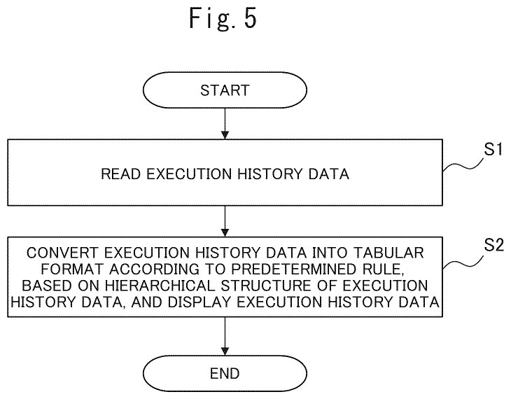

Hereinafter, a display function of the execution history data being provided as a function by history display unit 152, selection unit 153, and output unit 154 will be described. FIG. 5 is a flowchart illustrating history data display processing according to the embodiment. The history data display processing is activated by, for example, an operator operating the teach pendant 40 and performing an operation of instructing the robot controller 50 to start the history data display processing. The history data display processing is executed under control by processor 51 of robot controller 50.

As a precondition for executing the history data display processing (FIG. 5), it is assumed that the robot program and the vision program called from the robot program are executed in advance, and the execution history data are recorded in, for example, storage unit 155.

The execution history data of the vision program are assumed to have properties as follows as exemplifications.
(a1) An execution history includes, for example, an execution date and time, a vision program name, an image, a capturing position, a detection score, a contrast, detection position and posture, and the like.
(a2) values of the detection score, the contrast, the detection position and posture, and the like are recorded for the number of detected target objects.
(a3) Execution history has a hierarchical structure. A unit of the execution history is referred to as a record, and a hierarchy by the record is constituted in the execution history.
(a4) One record is recorded as the execution history in single execution of the program, and the record may have a plurality of records in a hierarchy.
(a5) Each record includes a pair of a key and a value.

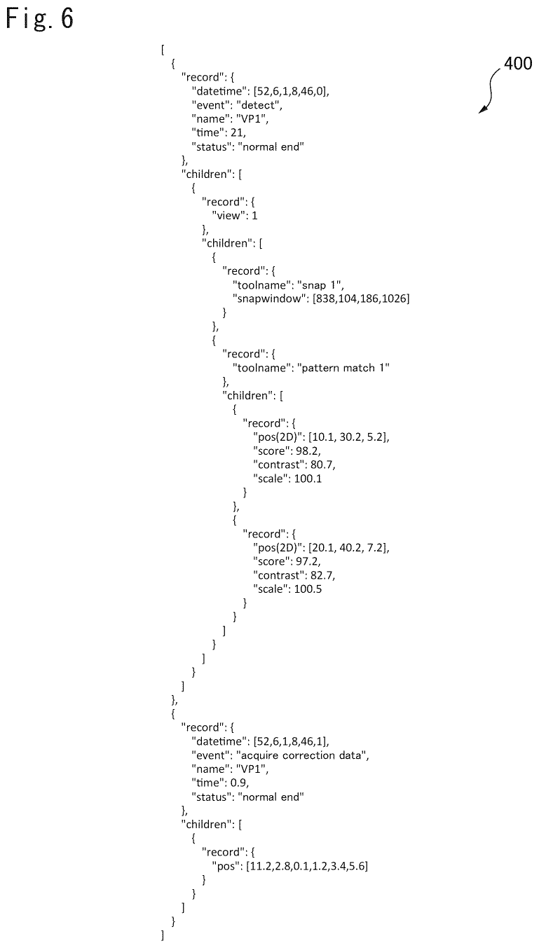

FIG. 6 illustrates an example of the execution history data acquired by executing the vision program. As illustrated in FIG. 6, execution history data 400 include a group of data formed on a record basis. In the execution history data 400, one record is divided by a character string “record: {}”, and a character string “children: ” is used for defining a record which is lower by one layer. The execution history data 400 include two uppermost layer records “event”: “detect” and “event”: “acquire correction data”. Each of the uppermost layer records has a hierarchical structure as follows.

```
Uppermost layer: record of ““event”: “detect””
Second layer: record of ““view”:1”
Third layer: record of ““toolname”: “snap 1””,
  record of “toolname”: ““pattern match 1””
Fourth layer: record of ““pos(2D)”: [10.1, 30.2, 5.2]”,
  record of ““pos(2D)”: [20.1, 40.2, 7.2]”
Uppermost layer: record of ““event”: “acquire correction data””
Second layer: record of ““pos”: [11.2, 2.8, 0.1, 1.2, 3.4, 5.6]”
```

The hierarchical structure of the execution history data may have various aspects depending on the configuration of a program. For example, in the vision program that outputs the record of “event “detect”” in the execution history data 400 in FIG. 6, blocks of “program: VP1”, “camera view 1”, “snap 1”, “pattern match 1”, and “pattern match 2” of the program are provided in a hierarchical manner as described below.

```
(program: VP1)
  (camera view 1)
    (snap 1)
    (pattern match 1)
    (pattern match 2)
```

The block “program: VP1” corresponds to a definition of the whole program. The block “camera view 1” corresponds to a definition of a first camera arranged in a system. The block “snap 1” corresponds to a definition of one piece of capturing. The blocks “pattern match 1” and “pattern match 2” correspond to definitions of two kinds of pattern matching. Herein, it can be considered that “program: VP1” corresponds to an uppermost layer, the block “camera view 1” corresponds to a second layer, the block “snap 1” corresponds to a third layer, the blocks “pattern match 1” and “pattern match 2” each correspond to a fourth layer. In this way, it can be said that the hierarchical structure of the execution history data depends on the hierarchical structure of the program.

Returning to the description of FIG. 5, first, history display unit 152 reads the execution history data from, for example, storage unit 155 of the robot controller 50 (step S1). Next, history display unit 152 converts the execution history data into tabular format, and displays the execution history data (step S2). The display of the execution history data may be performed by display on, for example, display screen 61 of display device 60. History display unit 152 may convert hierarchical execution history data into tabular format by using one or more rules below, and display the hierarchical execution history data converted into tabular format.
(r1) Values of keys of the same kind are displayed in the same column.
(r11) However, even the keys of the same kind are arranged in different columns according to which layer number of a record the key belongs.
(r12) The hierarchy represents the depth of a tree.
(r2) The columns are arranged and displayed in order of the hierarchy. In other words, a tag in an (N+1)-th layer is not displayed before a tag in an N-th layer.
(r3) The order of priority concerning the display order of the keys may be defined in advance. In this way, the order in which the columns are displayed is not changed by an order in which the records are read.
(r31) It does not mean that all of the columns defined herein are displayed, and means that the order in which the columns are displayed follows the order of priority.
(r4) The records are added to a row of a table while prioritizing the records extending in the depth direction in the hierarchy. In other words, even when a record (fraternal record) in the same layer is present with regard to a certain record, records extending, in the depth direction, from the certain record are prioritized and added to a row of a table.

Values of keys of the same kind are displayed in the same column by the rule (r1) described above. In this way, for example, a score as a detection result of each target object is arranged and displayed in a column direction of a table, and an analysis of the detection result can be efficiently performed. However, by arranging the keys of the same kind in different columns in a table when layers of the keys of the same kind are different, a hierarchical structure of the execution history data can be maintained in the table. As a result, the execution history data can be displayed in a manner beneficial to an operator (the rules (r11) and (r12) described above).

By the rule (r2) described above, orderliness of the hierarchical structure of the execution history data can be maintained in a table so that the execution history data can be displayed in a manner beneficial to an operator.

History display unit 152 may be configured to provide a function for performing setting of a priority order of display of keys for applying the rule (r3) described above. Information that sets the priority order of the display of the keys may be stored in, for example, storage unit 155. By setting the priority order of the display of the keys, for example, an order in which the keys in one record appear in a row of a table can be defined in a manner desired by an operator. For example, when parameters included in a record of a detection result are desired to be displayed in the order of a position, a score, a contrast, and a scale, an operator creates setting information that sets the order of priority of a position, a score, a contrast, and a scale. It should be noted that, also with regard to a plurality of parameters (keys) belonging to different records, an order in which the parameters appear in a row of a table can be defined by setting a priority order of display of the parameters.

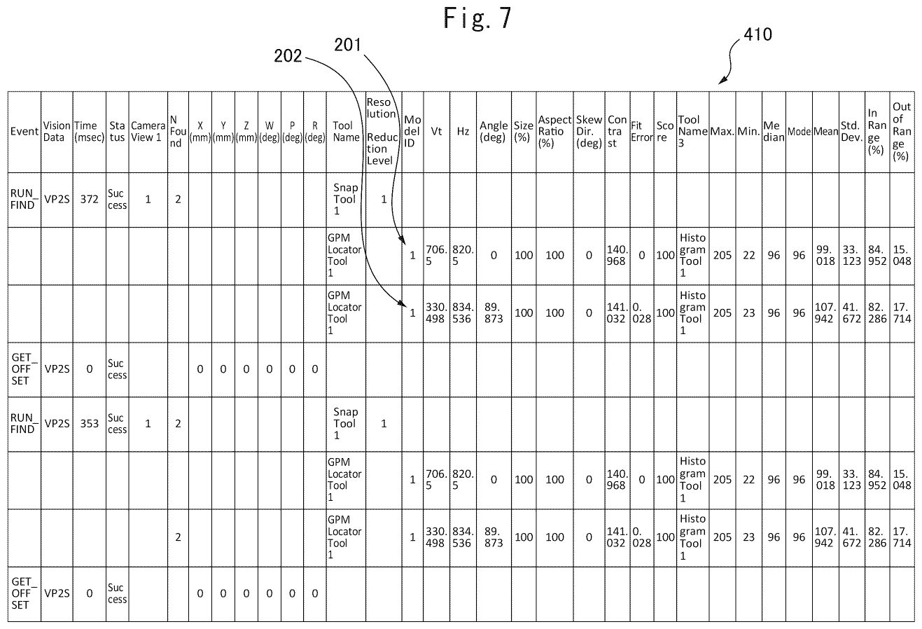

FIG. 7 illustrates an example of data in tabular format being acquired by converting the execution history data according to one or more of the rules (r1) to (r4) described above. Tabular data 410 illustrated in FIG. 7 include execution histories of four commands (“RUN_FIND”, “GET_OFFSET”, “RUN_FIND”, and “GET_OFFSET”). It should be noted that the command “RUN_FIND” corresponds to a command for detecting a target object, and the command “GET_OFFSET” corresponds to a command for acquiring a correction amount based on a detection result. The arrangement of the keys in the highest row of the tabular data represents that the keys are extracted in an order from the left to the right. The arrangement from the left to the right of the keys in the highest row of the tabular data 410 corresponds to an appearance order of the keys in the depth direction of the hierarchical structure of the execution history data.

The execution history “RUN_FIND” in the highest row of tabular data 410 includes two detection results, and the two detection results are each displayed in different rows (reference signs 201 and 202). Since the two detection results (reference signs 201 and 202) are records in the same layer in the execution history data, a value of each of keys (such as Vt, Hz, Angle (deg), Size (%), Aspect Ratio (%), Skew Dir. (deg), Contrast, Fit Error, and Score) in the records is displayed in the same column in each row. It should be noted that the third execution history “RUN_FIND” from the top in the tabular data 410 also similarly includes two detection results.

The second and fourth execution histories “GET_OFFSET” from the top in tabular data 410 include correction amounts (X (mm), Y (mm), Z (mm), W (deg), P (deg), and R (deg)).

In this way, tabular data 410 are configured to reflect an arrangement of keys in the depth direction of the execution history data in an arrangement of the keys in the row direction of a table, and expand a record in the same hierarchy of the execution history data in the row direction of the table. In other words, tabular data 410 are configured to reflect the hierarchical structure of the execution history data, and also make it easy to visually recognize the hierarchical structure of the execution history data. Therefore, an operator can easily and quickly recognize the content of an execution history by viewing tabular data 410.

As exemplified in tabular data 410, when an execution history is presented across a plurality of rows (such as the execution history “RUN_FIND” in the highest row in FIG. 7), a display style in which cells corresponding to a parent record are connected in a vertical direction, a value of a cell of the parent record is repeatedly provided in a cell in each row, and the like may be adopted in order to prevent a cell corresponding to the parent record in each row from becoming a blank cell. In this case, for the execution history “RUN_FIND” in the highest row being presented across three rows in tabular data 410,
a display style in which
three cells (such as three cells of “Vision Data” in the vertical direction) in the vertical direction corresponding to a parent record are connected and displayed as one cell, or
a value (“VP25” in a case of “Vision Data”) of the parent record is repeatedly displayed in each of the three cells (such as the three cells of “Vision Data” in the vertical direction) corresponding to the parent record
is adopted.

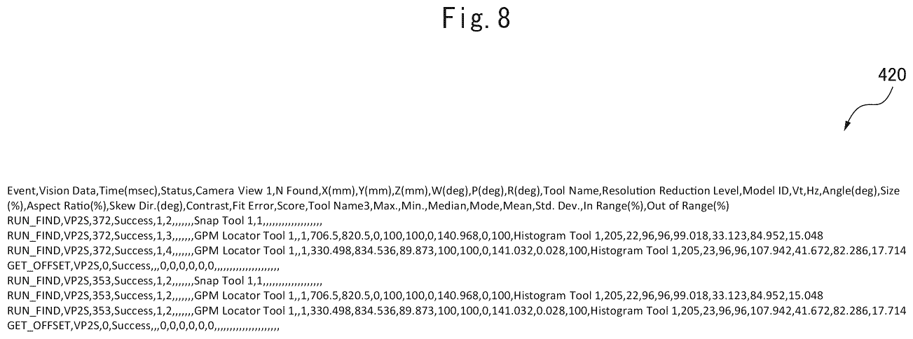

Output unit 154 outputs, as a file of tabular data, the execution history data displayed in tabular format as described above. FIG. 8 illustrates a state where tabular data 410 are output as table data file 420. Table data file 420 is configured to represent tabular format by using specific punctuation symbols (a comma and a newline in the present example). CSV format may be used as table data file 420.

The function of selecting display data (keys and values thereof to be displayed) by selection unit 153, i.e., the function of narrowing down the display data will be described. Selection unit 153 provides the following selection functions by the value of a key.
(Function 1) A function of narrowing down information desired to be viewed by the value of a key
(Function 1-1) Whether the value of a specific key coincides or does not coincide with a specific value
(Function 1-2) Whether the value of a specific key falls within or falls outside a predetermined range

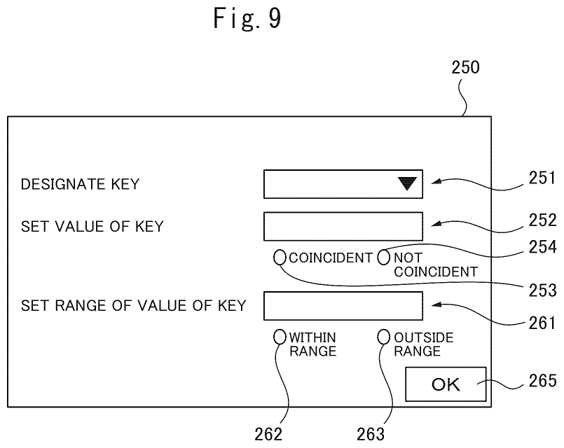

Selection unit 153 may be configured to provide a setting screen (user interface screen) for setting a narrowing criterion and accept designation of the narrowing criterion from a user. FIG. 9 illustrates an example of a setting screen for setting the narrowing criteria provided by selection unit 153. Setting screen 250 in FIG. 9 may be displayed on, for example, display device 60, and a setting input on setting screen 250 may be performed via an operation unit of display device 60. As illustrated in FIG. 9, setting screen 250 includes a designation column 251 for designating a key, a column 252 for designating a value of the key, and buttons 253 and 254 for designating which of a case of coincidence with the value of the key and a case of not coincidence with the value of the key is to be applied.

Setting screen 250 further includes a column 261 for setting a range of the value of the key, and buttons 262 and 263 for designating which of a case where the value falls within the set range and a case where the value falls outside the set range is to be applied. When an operator performs setting on setting screen 250 and presses an OK button 265, selection unit 153 narrows down display data according to the narrowing criteria input to setting screen 250. By this function, for example, the operator can extract only a detection result in which a detection score falls within a range of a certain value, and display the detection result as data in tabular format. Such a function allows the operator to efficiently carry out an analysis of an execution history.

The operator can check, on the display screen, the tabular data being narrowed down and displayed, and output it to a file as it is through the functions of selection unit 153 and output unit 154. When a plurality of child records are defined for one parent record in the execution history data, the child records are each displayed in a plurality of rows. When child records are displayed in a plurality of rows in such a manner, data about a parent record may be repeatedly included in the row of each of the child records. Also, in a case where the tabular data are output to a file, when child records are displayed in a plurality of rows, data about a parent record may be repeatedly included in the row of each of the child records.

A selection criterion when selection of display data is performed by selection unit 153 may be registered in advance in storage unit 155, and selection unit 153 may be configured to perform selection of display data according to the selection criterion stored in storage unit 153. In this case, by registering the selection criterion in advance, for example, the operator can check execution result of a program by the same selection criterion. It should be noted that this function can also be achieved by describing a criterion (selection criterion) in a program (such as a robot program and a vision program) so that execution history data output from the program have contents selected by the selection criterion.

The function as selection unit 153 for outputting, as a file in tabular format, the execution history data displayed in tabular format may be included in display device 60. In this case, display device 60 outputs, as a data file in tabular format, the execution history data displayed in tabular format on display screen 61. In this configuration, conversion into a data file in tabular format is performed by using hardware and software resources of display device 60, and thus a processing load on the robot controller 50 can be reduced and processing on the robot controller 50 side can be performed at a high speed.

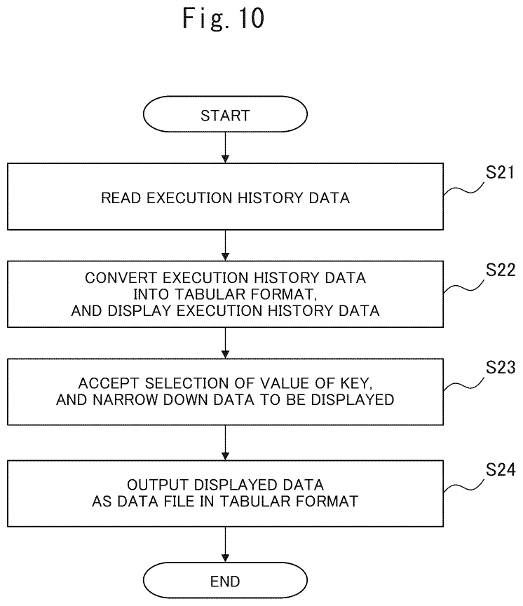

FIG. 10 is a flowchart illustrating a second example of the history data display processing executed by robot controller 50. The flowchart illustrated in FIG. 10 is an example of the history data display processing when the above-described functions of selection unit 153 and output unit 154 are included in addition to the function of history display unit 152. The present history data display processing is executed under control by processor 51 of robot controller 50.

First, history display unit 152 reads the execution history data from, for example, storage unit 155 (step S21). Next, history display unit 152 converts the read history data into tabular format, and displays the history data on a display screen (step S22). The display of the execution history data may be performed on, for example, display screen 61 of display device 60.

Next, selection unit 153 selects and narrows down a display content of the execution history data being displayed in tabular format, based on the settings input by an operator (step S23). The setting of a narrowing criterion by the operator may be performed via setting screen 250 as described above.

Next, for example, in response to an operation of instructing output of a file by the operator, output unit 154 outputs, as a data file in tabular format, the execution history data displayed in tabular format (step S24). The data file of the execution history data being output in such a manner can be analyzed, displayed, printed, and used by various external devices.

The first embodiment described above is the example relating to display of the execution history data when the robot system includes the visual sensor as the sensor. As a modification example of the embodiment described above, a configuration example relating to display of the execution history data when the robot system includes a force sensor as a sensor and a force control program is executed in the robot system will be described below as a second embodiment.

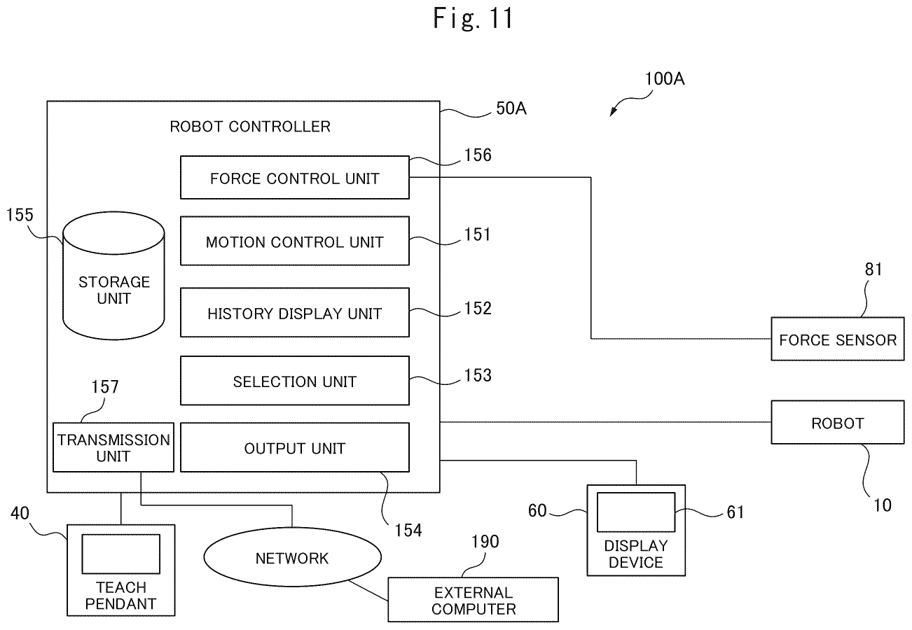

FIG. 11 illustrates a configuration of robot system 100A according to the second embodiment, and also illustrates a block diagram of robot controller 50A. In FIG. 11, the same component as the component according to the first embodiment is provided with the same reference sign, and description thereof is simplified or omitted. As illustrated in FIG. 11, robot system 100A includes robot 10, robot controller 50A that controls robot 10, force sensor 81, teach pendant 40, and display device 60. Force sensor 81 is arranged between, for example, a tool (such as a hand) of robot 10 and a wrist flange, and detects external force applied to the tool. Various types of tools may be used according to the content of work. Force sensor 81 is, for example, a 6-axis force sensor that detects force in each of X, Y, and Z-axis directions and torque around each axis.

Robot controller 50A includes force control unit 156 that executes force control. A force control program for executing the force control and various parameters relating to the force control are registered in advance in storage unit 155 of robot controller 50A. The force control program may include a program for performing precision fitting, polishing work, and the like. The execution history data are generated and recorded by executing the force control program. The execution history data may be stored in, for example, storage unit 155.

An execution history in a case of the force control includes, for example, a start date and time, a force control program name, a position, a value of force and torque in each axis direction, and the like. The execution histories are recorded at fixed time intervals during single execution of the force control program. For example, the execution history data have a structure including a plurality of child records being recorded at fixed time intervals during single execution of the force control program.

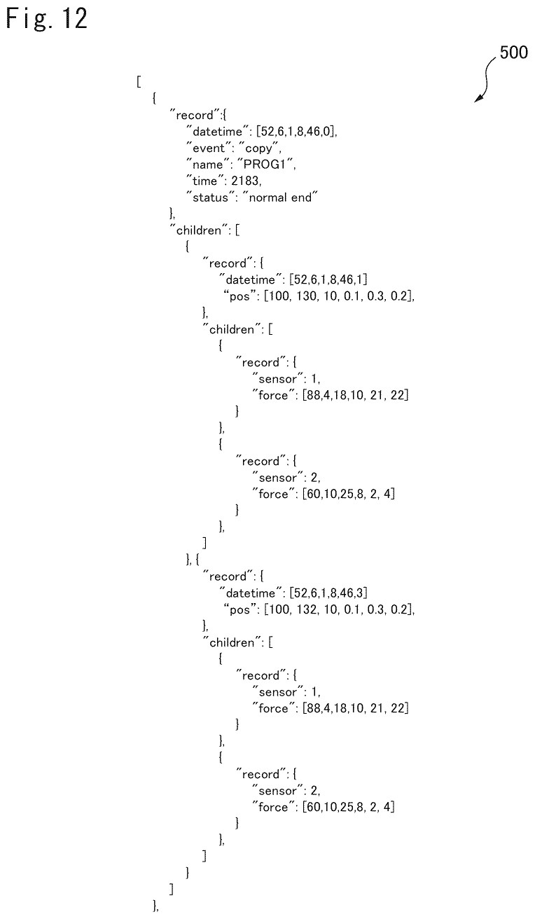

FIG. 12 illustrates an example of the execution history data generated by executing the force control program. Execution history data 500 illustrated in FIG. 12 have a structure in which the following records extend under a record in the uppermost layer (a record of a program name “name”: “PROG1”).
A child record (a record in a second layer) (a record of position “pos”: [100, 130, 10, 0.1, 0.3, 0.2]) and two grandchild records (records in a third layer) (“sensor”: 1 and “sensor”: 2)
A child record (a record in a second layer) (a record of position “pos”: [100, 132, 10, 0.1, 0.3, 0.2]) and two grandchild records (records in a third layer) (“sensor”: 1 and “sensor”: 2)

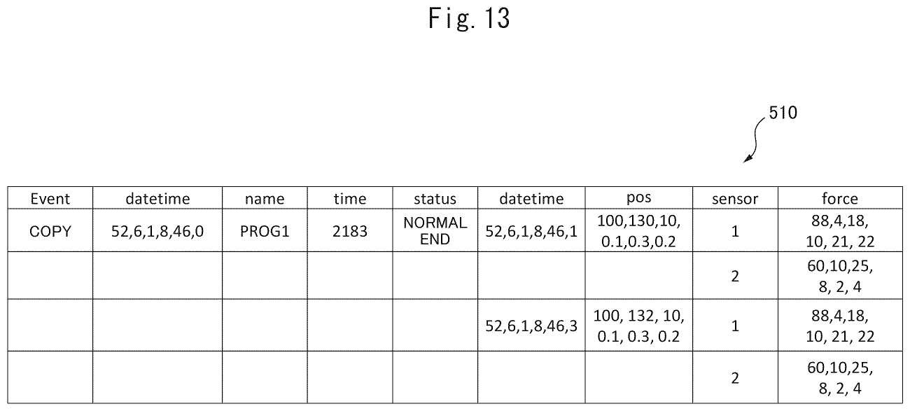

History display unit 152 converts the execution history data having the hierarchical structure as in FIG. 12 into tabular format, and displays the execution history data on, for example, display screen 61 of display device 60. FIG. 13 is a display example when the execution history data 500 are represented as tabular data 510 according to one or more of the rules (r1) to (r4) described above. Tabular data 510 illustrated in FIG. 13 are configured to reflect an arrangement of keys in the depth direction of execution history data 500 in an arrangement of the keys in the row direction of a table, and expand a record in the same layer of execution history data 500 in the row direction of the table. In other words, tabular data 510 are configured to reflect the hierarchical structure of execution history data 500, and also make it easy to visually recognize the hierarchical structure. Therefore, an operator can easily and quickly recognize the content of an execution history by viewing the tabular data 510.

Also, in the present example, selection unit 153 provides a function of narrowing down a display content by a value of a key and the like. For example, a display content may be narrowed down by a key “force” of an output value of the force sensor and a value of the key.

Output unit 154 can output, as a data file in tabular format, the execution history data in tabular format being displayed as illustrated in FIG. 13.

As described above, also in the operation environment in which the force sensor is mounted as the sensor and the force control program is executed in the robot system, robot controller 50A can display the execution history data in such a way that the execution history data can be used effectively by a user.

According to each of the embodiments described above, the execution history data can be displayed in such a way that the execution history data can be used effectively by a user.

Arrangement of the functional blocks in the functional block diagrams (FIGS. 3 and 11) described in the embodiments described above is an example, and various modification examples of arrangement of the functional blocks are possible. For example, the whole function of the robot controller and the display device may be defined as a controller.

In the embodiments described above, the example of performing display of the execution history data on the display device is described, but display of the execution history data may be performed on a display screen of the teach pendant. Further, display of various setting screens (such as setting screen 250) and an input to the setting screen may be performed via the display screen and the operation unit of the teach pendant. In this case, the whole function of the robot controller and the teach pendant can also be defined as a controller.

The execution history data generated by execution of a vision program may be stored in storage unit 122 of visual sensor control device 20.

The embodiments described above are the example of applying the configuration relating to display of the execution history data to the robot system including the sensor, but the configuration relating to display of the execution history data in the embodiments described above can be applied to a system of various industrial machines including a sensor.

The functional blocks of the robot controller illustrated in FIGS. 3 and 11 may be achieved by executing various types of software stored in the storage device by the processor of the robot controller, or may be achieved by a configuration in which hardware such as an application specific integrated circuit (ASIC) is a main body.

The computer program for executing various types of processing such as the execution history data display processing in the embodiments described above can be recorded in various computer-readable recording media (for example, a ROM, an EEPROM, a semiconductor memory such as a flash memory, a magnetic recording medium, and an optical disk such as a CD-ROM and a DVD-ROM).

Although the present disclosure has been described above in detail, the present disclosure is not limited to the individual embodiments described above. Various types of addition, replacement, modification, partial deletion, and the like may be made to the embodiments without departing from the purpose of the present disclosure or without departing from the contents described in the claims and the scope of the present disclosure derived from equivalents thereof. Further, the embodiments can be performed in combination. For example, in the embodiments described above, an order of operations and an order of pieces of processing are indicated as one example, which is not limited thereto. Further, the same also applies to a case where a numerical value or a numerical expression is used in the description of the embodiments described above.

With regard to the embodiments and the modification examples described above, supplementary notes below are further described.

### (Supplementary Note 1)

A controller (50, 50A) for controlling an industrial machine, the controller including:
a storage unit (155) configured to store execution history data when a program for causing the industrial machine to perform predetermined work is executed; and
a history display unit (152) configured to display, on a display screen, the execution history data in tabular format, based on a hierarchical structure of the execution history data.

### (Supplementary Note 2)

A controller (50, 50A) for controlling an industrial machine, the controller including:
a storage unit (155) configured to store execution history data when a program for causing the industrial machine to perform predetermined work is executed;
a history display unit (152) configured to display, on a display screen, the execution history data in tabular format;
a selection unit (153) configured to select, from the execution history data, data to be displayed in the tabular format on the display screen by the history display unit; and
an output unit (154) configured to output, as a data file in tabular format, the execution history data displayed in the tabular format on the display screen.

### (Supplementary Note 3)

The controller according to supplementary note 2, wherein
the history display unit (152) displays the execution history data in tabular format, based on a hierarchical structure of the execution history data.

### (Supplementary Note 4)

The controller according to supplementary note 2 or 3, wherein
the selection unit (153) accepts an input for selecting data to be displayed in the tabular format by a value of a key of the execution history data.

### (Supplementary Note 5)

The controller according to supplementary note 1 or 3, wherein
the history display unit (152) sets the execution history data in tabular format according to a predetermined rule.

### (Supplementary Note 6)

The controller according to supplementary note 5, wherein
the predetermined rule includes displaying, in the same column, data of keys of the same kind in the execution history data.

### (Supplementary Note 7)

The controller according to supplementary note 6, wherein
the predetermined rule includes arranging, in the same column, data of keys of the same kind and in the same layer in the execution history data.

### (Supplementary Note 8)

The controller according to any one of supplementary notes 5 to 7, wherein,
when there are a plurality of pieces of data in the same layer, the predetermined rule includes displaying, in different rows, the data in the same layer by line feeding.

### (Supplementary Note 9)

The controller according to supplementary note 8, wherein
the predetermined rule includes repeatedly displaying, in each row in which data in the same layer are displayed, data in a parent layer to which the data in the same layer belong.

### (Supplementary Note 10)

The controller according to any one of supplementary notes 5 to 9, wherein
the predetermined rule includes adding data in each layer to one row in an order according to an order of a depth of the each layer in the execution history data.

### (Supplementary Note 11)

The controller according to any one of supplementary notes 5 to 10, wherein
the predetermined rule includes adding data of keys to one row in an order according to information that defines a display order of the keys.

### (Supplementary Note 12)

The controller according to any one of supplementary notes 5 to 11, wherein,
when the hierarchical structure of the execution history data includes layers extending from one layer in a depth direction of the hierarchy structure and a layer of which a rank is the same as the one layer, the predetermined rule includes putting a higher priority on adding, to a row, data in the layers extending from the one layer in the depth direction in order.

### (Supplementary Note 13)

The controller according to any one of supplementary notes 1 to 12, wherein
the program includes processing using a sensor, and
the execution history data include at least one of an output from the sensor and a result of processing the output from the sensor.

### (Supplementary Note 14)

The controller according to supplementary note 13, wherein
the sensor is a visual sensor (70), and
the execution history data include at least one of an image captured by the visual sensor and a result of executing image processing on the image.

### (Supplementary Note 15)

The controller according to any one of supplementary notes 1 to 14, further including
a transmission unit (157) configured to transmit the execution history data in the tabular format to an external device, wherein
the execution history data in the tabular format are displayed on the external device.

### (Supplementary Note 16)

The controller according to supplementary note 2, wherein
the selection unit (153) performs selection of data to be displayed in the tabular format according to a preset selection criterion.

### (Supplementary Note 17)

The controller according to supplementary note 1, wherein
the program is configured to select data to be output as execution history data according to a selection criterion described in the program.

### (Supplementary Note 18)

A system (100, 100A) of an industrial machine, including:
an industrial machine (10); and
a controller (50, 50A) configured to control the industrial machine, wherein
the controller (50, 50A) includes
a storage unit (155) configured to store execution history data when a program for causing the industrial machine to perform predetermined work is executed, and
a history display unit (152) configured to display, on a display screen, the execution history data in tabular format, based on a hierarchical structure of the execution history data.

### (Supplementary Note 19)

A system (100, 100A) of an industrial machine, including:
an industrial machine (10); and
a controller (50, 50A) configured to control the industrial machine, wherein
the controller (50, 50A) includes
a storage unit (155) configured to store execution history data when a program for causing the industrial machine to perform predetermined work is executed,
a history display unit (152) configured to display, on a display screen, the execution history data in tabular format,
a selection unit (153) configured to select, from the execution history data, data to be displayed in the tabular format on the display screen by the history display unit, and
an output unit (154) configured to output, as a data file in tabular format, the execution history data displayed in the tabular format on the display screen.

### (Supplementary Note 20)

The system (100, 100A) of an industrial machine according to supplementary note 18 or 19, wherein
the controller (50, 50A) further includes a transmission unit (157) configured to transmit the execution history data in the tabular format to an external device, and
the execution history data in the tabular format are displayed on the external device.

### (Supplementary Note 21)

An execution history data display method executed on a computer, the execution history data display method including:
reading, from a storage unit (155), execution history data when a program for causing an industrial machine (10) to perform predetermined work is executed; and
displaying, on a display screen, the execution history data in tabular format, based on a hierarchical structure of the read execution history data.

### (Supplementary Note 22)

An execution history data display method executed on a computer, the execution history data display method including:
reading, from a storage unit (155), execution history data when a program for causing an industrial machine (10) to perform predetermined work is executed;
displaying, on a display screen, the execution history data in tabular format;
selecting, from the execution history data, data to be displayed in the tabular format on the display screen; and
outputting, as a data file in tabular format, the execution history data displayed in the tabular format on the display screen.

### (Supplementary Note 23)

A program for causing a processor of a computer to execute:
reading, from a storage unit (155), execution history data when a program for causing an industrial machine (10) to perform predetermined work is executed; and
displaying, on a display screen, the execution history data in tabular format, based on a hierarchical structure of the read execution history data.

### (Supplementary Note 24)

A program for causing a processor of a computer to execute:
reading, from a storage unit (155), execution history data when a program for causing an industrial machine (10) to perform predetermined work is executed;
displaying, on a display screen, the execution history data in tabular format;
selecting, from the execution history data, data to be displayed in the tabular format on the display screen; and
outputting, as a data file in tabular format, the execution history data displayed in the tabular format on the display screen.

### REFERENCE SIGNS LIST

10 Robot
20 Visual sensor control device
33 Hand
40 Teach pendant
50, 50A Robot controller
41, 51 Processor
42, 52 Memory
43 Display unit
44, 54 Operation unit
45, 53 Input/output interface
60 Display device
61 Display screen
70 Visual sensor
81 Force sensor
100, 100A Robot system
121 Image processing unit
122 Storage unit
151 Motion control unit
152 History display unit
153 Selection unit
154 Output unit
155 Storage unit
156 Force control unit
157 Transmission unit
190 External computer
250 Setting screen
400, 500 Execution history data
410, 510 Tabular data
420 Table data file

1. A controller for controlling an industrial machine, the controller comprising:
a storage unit configured to store execution history data when a program for causing the industrial machine to perform predetermined work is executed; and
a history display unit configured to display, on a display screen, the execution history data in tabular format, based on a hierarchical structure of the execution history data.

2. A controller for controlling an industrial machine, the controller comprising:
a storage unit configured to store execution history data when a program for causing the industrial machine to perform predetermined work is executed;
a history display unit configured to display, on a display screen, the execution history data in tabular format;
a selection unit configured to select, from the execution history data, data to be displayed in the tabular format on the display screen by the history display unit; and
an output unit configured to output, as a data file in tabular format, the execution history data displayed in the tabular format on the display screen.

3. The controller according to claim 2, wherein the history display unit displays the execution history data in tabular format, based on a hierarchical structure of the execution history data.

4. The controller according to claim 2, wherein the selection unit accepts an input for selecting data to be displayed in the tabular format by a value of a key of the execution history data.

5. The controller according to claim 1, wherein the history display unit sets the execution history data in tabular format according to a predetermined rule.

6. The controller according to claim 5, wherein the predetermined rule includes displaying, in the same column, data of keys of the same kind in the execution history data.

7. The controller according to claim 6, wherein the predetermined rule includes arranging, in the same column, data of keys of the same kind and in the same layer in the execution history data.

8. The controller according to claim 5, wherein when there are a plurality of pieces of data in the same layer, the predetermined rule includes displaying, in different rows, the data in the same layer by line feeding.

9. The controller according to claim 8, wherein the predetermined rule includes repeatedly displaying, in each row in which data in the same layer are displayed, data in a parent layer to which the data in the same layer belong.

10. The controller according to claim 5, wherein the predetermined rule includes adding data in each layer to one row in an order according to an order of a depth of the each layer in the execution history data.

11. The controller according to claim 5, wherein the predetermined rule includes adding data of keys to one row in an order according to information that defines a display order of the keys.

12. The controller according to claim 5, wherein when the hierarchical structure of the execution history data includes layers extending from one layer in a depth direction of the hierarchical structure and a layer of which a rank is the same as the one layer, the predetermined rule includes putting a higher priority on adding, to a row, data in the layers extending from the one layer in the depth direction in order.

13. The controller according to claim 1, wherein
the program includes processing using a sensor, and
the execution history data include at least one of an output from the sensor and a result of processing the output from the sensor.

14. The controller according to claim 13, wherein
the sensor is a visual sensor, and
the execution history data include at least one of an image captured by the visual sensor and a result of executing image processing on the image.

15. The controller according to claim 1, further comprising:
a transmission unit configured to transmit the execution history data in the tabular format to an external device, wherein
the execution history data in the tabular format are displayed on the external device.

16. The controller according to claim 2, wherein the selection unit performs selection of data to be displayed in the tabular format according to a preset selection criterion.

17. The controller according to claim 1, wherein the program is configured to select data to be output as execution history data according to a selection criterion described in the program.

18. A system of an industrial machine, comprising:
an industrial machine; and
a controller configured to control the industrial machine, wherein
the controller includes
a storage unit configured to store execution history data when a program for causing the industrial machine to perform predetermined work is executed, and
a history display unit configured to display, on a display screen, the execution history data in tabular format, based on a hierarchical structure of the execution history data.

19. A system of an industrial machine, comprising:
an industrial machine; and
a controller configured to control the industrial machine, wherein
the controller includes
a storage unit configured to store execution history data when a program for causing the industrial machine to perform predetermined work is executed,
a history display unit configured to display, on a display screen, the execution history data in tabular format,
a selection unit configured to select, from the execution history data, data to be displayed in the tabular format on the display screen by the history display unit, and
an output unit configured to output, as a data file in tabular format, the execution history data displayed in the tabular format on the display screen.

20. The system of an industrial machine according to claim 18, wherein
the controller further includes a transmission unit configured to transmit the execution history data in the tabular format to an external device, and
the execution history data in the tabular format are displayed on the external device.

21. An execution history data display method executed on a computer, the execution history data display method comprising:
reading, from a storage unit, execution history data when a program for causing an industrial machine to perform predetermined work is executed; and
displaying, on a display screen, the execution history data in tabular format, based on a hierarchical structure of the read execution history data.

22. An execution history data display method executed on a computer, the execution history data display method comprising:
reading, from a storage unit, execution history data when a program for causing an industrial machine to perform predetermined work is executed;
displaying, on a display screen, the execution history data in tabular format;
selecting, from the execution history data, data to be displayed in the tabular format on the display screen; and
outputting, as a data file in tabular format, the execution history data displayed in the tabular format on the display screen.

23. A non-transitory computer readable storage medium storing instructions that, when executed by a processor of a computer, cause the processor to perform:
reading, from a storage unit, execution history data when a program for causing an industrial machine to perform predetermined work is executed; and
displaying, on a display screen, the execution history data in tabular format, based on a hierarchical structure of the read execution history data.

24. A non-transitory computer readable storage medium storing instructions that, when executed by a processor of a computer, cause the processor to perform:
reading, from a storage unit, execution history data when a program for causing an industrial machine to perform predetermined work is executed;
displaying, on a display screen, the execution history data in tabular format;
selecting, from the execution history data, data to be displayed in the tabular format on the display screen; and
outputting, as a data file in tabular format, the execution history data displayed in the tabular format on the display screen.

25. The controller according to claim 2, wherein the execution history data are generated in accordance with a configuration of the program.
